(19) United States
(12) Patent Application Publication
(10) Pub. No.: US 2013/0227257 A1
(43) Pub. Date: Aug. 29, 2013

(54) DATA PROCESSOR WITH ASYNCHRONOUS RESET

(71) Applicants: Nitin Singh, Janakpuri (IN); Arjun Pal Chowdhury, Kolkata (IN)

(72) Inventors: Nitin Singh, Janakpuri (IN); Arjun Pal Chowdhury, Kolkata (IN)

(73) Assignee: FREESCALE SEMICONDUCTOR, INC, Austin, TX (US)

(21) Appl. No.: 13/403,969

(22) Filed: Feb. 23, 2012

(51) Int. Cl. G06F 9/06; G06F 12/02

(52) U.S. Cl. 713/1

(57) ABSTRACT

A data processor includes a reset controller for controlling reset of the processing system and a volatile memory controller for controlling writing data to a volatile memory module, typically a RAM module. The reset controller responds to an asynchronous reset signal to inhibit write operations of the volatile memory controller to the volatile memory module and to delay reset of the processing system until the write operations have been inhibited.

### BACKGROUND OF THE INVENTION

The present invention is directed to data processors, and more particularly to an asynchronous system reset of a data processor.

A common form of volatile memory is random access memory (RAM). A processor may be a micro-controller unit (MCU) or a microprocessor, for example, and the processing system may have one or more processor cores, peripherals such as input/output devices (I/Os) and non-volatile memory for programs. A processor also includes a reset controller for setting the registers, flip-flops, gates and other elements of the processing system to a defined condition or logical state that is independent of any errors or meta-stable events. Reset is performed when power is switched ON or restored, referred to as power-on reset. Reset is also typically performed when an error condition hampers reliable processing and when error recovery mechanisms, like retry or abort, fail.

The reset controller may assert a reset signal on a reset bus to trigger reset synchronously or asynchronously with a system clock. Synchronous system resets include software resets and watchdog resets. Asynchronous resets occur without synchronization with the system clock when an asynchronous reset signal is asserted on a reset input pin, or in the presence of disturbances (‘glitches’) to the system clock. Asynchronous system resets may cause immediate asynchronous change in volatile memory input signals or clock signals, which can result in meta-stability at interfaces with and in the volatile memory, causing write data errors and corruption of the memory data.

Volatile memory data could be protected from corruption by resets if all resets were asserted synchronously. However, deriving a synchronous system reset operation from assertion of an asynchronous reset signal is complicated. For example, it is difficult to ensure proper timing of the synchronous system reset operation throughout the processing system and the synchronous system reset operation involves many changes in program and application libraries. Therefore, it would be advantageous to ensure that memory data is not corrupted during an asynchronous system reset.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic block diagram of part of a known data processor;

FIG. 2 is a timing diagram of signals appearing in one possible situation during operation of the data processor of FIG. 1;

FIG. 3 is a timing diagram of signals appearing in another possible situation during operation of the data processor of FIG. 1;

FIG. 4 is a schematic block diagram of part of a data processor in accordance with one embodiment of the present invention, given by way of example;

FIG. 5 is a timing diagram of signals appearing in operation of the data processor of FIG. 4; and

FIG. 6 is a simplified flow chart of a method of performing reset of a processing system in a data processor in accordance with one embodiment of the invention, given by way of example.

### DETAILED DESCRIPTION OF PREFERRED EMBODIMENTS

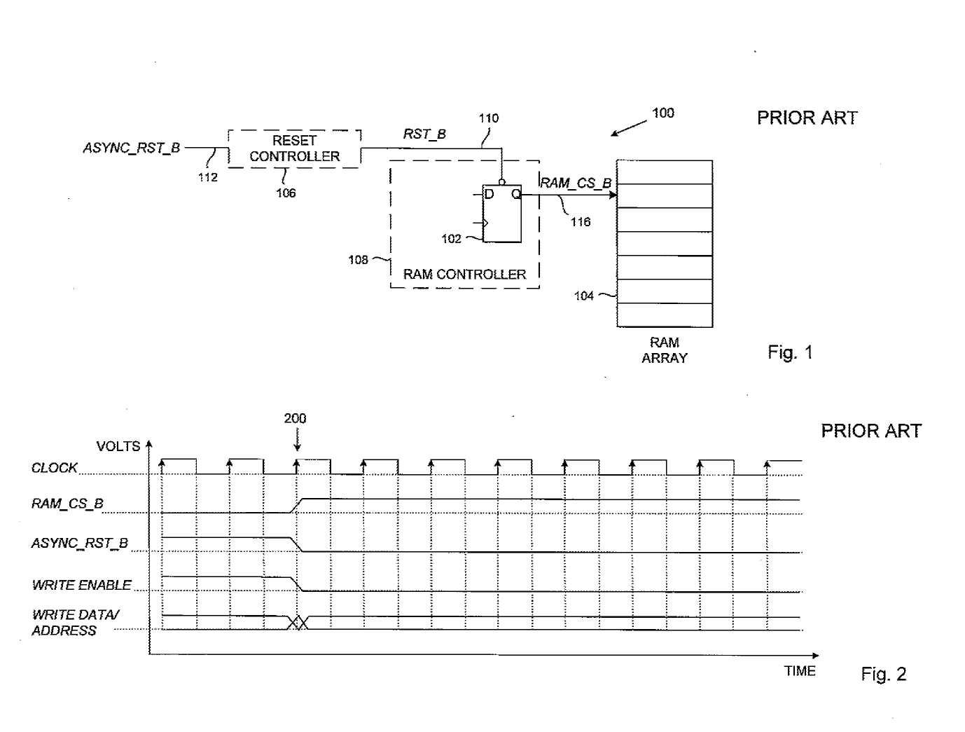

FIGS. 1, 2 and 3 illustrate a known data processor 100 and signals appearing during its operation. The data processor 100 has a processing system 102, symbolized by a processor flip-flop, and volatile memory, in this case a random access memory (RAM) module 104, one array of which is shown. It will be appreciated that the complete processing system 102 typically includes a large number of flip-flops, as well as registers, gates and input/output devices (I/Os) and may include non-volatile memory (not shown) for programs. The RAM module may have a number of RAM arrays. The RAM module 104 is volatile static memory (SRAM) for data in this example.

The data processor 100 also includes a reset controller 106 for controlling reset of the processing system 102, and a RAM controller 108 for controlling access to the RAM module 104 including writing data to the RAM module 104. The operation of the processing system 102 and of the RAM controller 108 is synchronized by system clock signals CLOCK. The reset controller 106 asserts a reset signal to trigger reset. The processor 100 uses complementary logic for reset signals so that assertion of the reset signal corresponds to the voltage of a complementary reset signal RST_B on a reset bus 110 being set to low.

The reset controller 106 asserts the reset signal RST_B to trigger reset synchronously with the system clock signal CLOCK, or asynchronously, or when power supply voltage is initially applied or is restored in a power-on reset. Synchronous system resets include software resets and watchdog resets. Asynchronous resets occur when an asynchronous complementary reset signal ASYNC_RST_B is asserted on a reset input pin 112 without synchronization with the system clock signal CLOCK, or in the presence of disturbances (glitches) to the system clock signal CLOCK. The reset controller 106 asserts the reset signal RST_B on the reset bus 110 immediately when it receives a reset request on the pin 112, for a reset in the relevant domain of the processing system 102. The assertion of the reset signal RST_B resets the elements of the processing system 102 to a defined state, in this example by the reset signal applied to reset inputs of the elements of the processing system forcing the output Q of the elements to de-assert.

The RAM controller 108 provides control signals RAM_CS_B on a line 116 input to the RAM module 104 for RAM write operations of the output signals of the processing system 102. The RAM controller 108 also provides control signals WRITE_ENABLE and data signals WRITE_DATA and WRITE_ADDRESS (not shown in FIG. 1) to the RAM module 104.

Since the signals RAM_CS_B, WRITE_ENABLE, WRITE_DATA and WRITE_ADDRESS applied to the input of the RAM module 104 are normally synchronized with the system clock signals CLOCK but the asynchronous reset signals ASYNC_RST_B are not, reset may occur while a write operation is occurring, with a consequent risk of corruption of the data stored in the RAM module 104, as illustrated in FIG. 2 at 200.

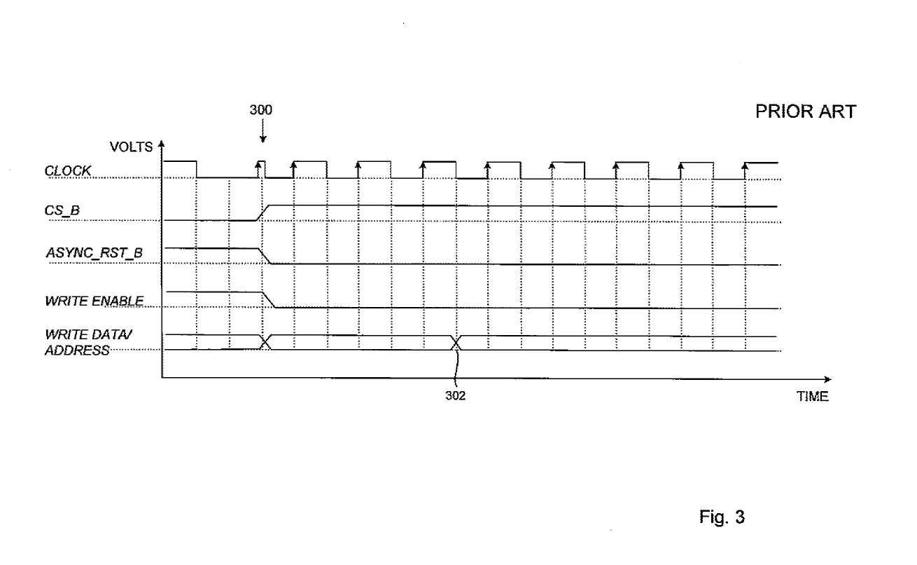

Also, as illustrated in FIG. 3, an asynchronous reset event may cause the system clock to switch asynchronously to a default clock generator (not shown), which can produce a disturbance or glitch in the system clock signal CLOCK, as shown at 300. Such a glitch may perturb the write operation as shown at 302, again causing a risk of corruption of the data stored in the RAM module 104.

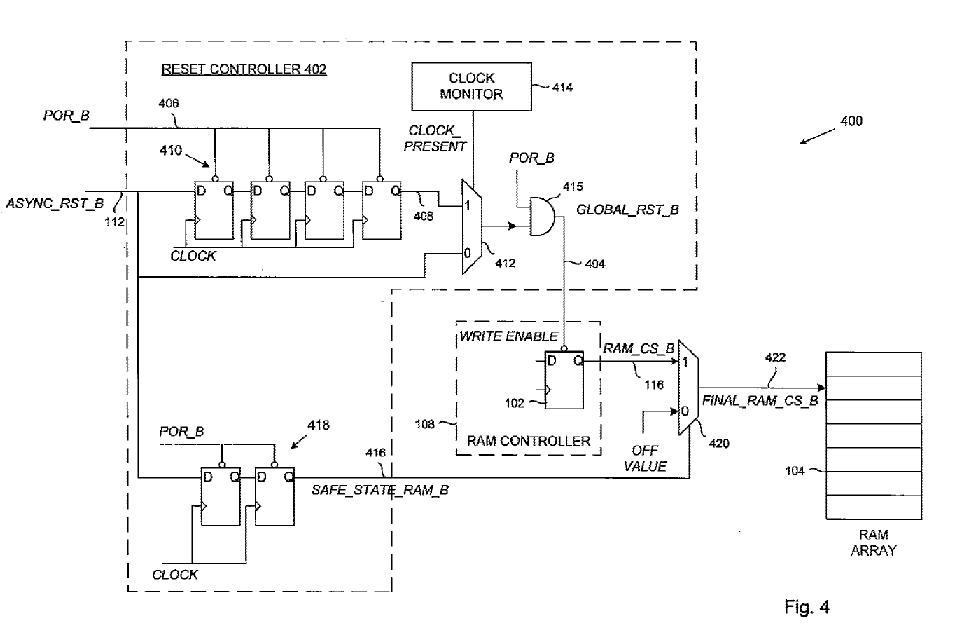

FIGS. 4, 5 and 6 illustrate examples of a data processor 400, signals appearing during operation of the data processor 400, and a method 600 of operating a data processor in accordance with embodiments of the invention. The data processor 400, like the processor 100, includes the processing system 102, symbolized by a processor flip-flop, and a volatile memory module 104. The processing system 102 includes a large number of other flip-flops, as well as registers, gates and I/O devices and non-volatile memory for programs (not shown). In this example, the volatile memory module 104 is a RAM, one array of which is shown, but the invention is also applicable to other forms of volatile memory. The RAM 104 may have a number of RAM arrays and is volatile SRAM in this example.

The data processor 400 also includes a reset controller 402 for controlling reset of the processing system 102 and a volatile memory controller 108 for controlling access to the RAM 104 including writing data to the RAM 104. The operations of the processing system 102 and of the volatile memory controller 108 are synchronized by system clock signals CLOCK. The reset controller 402 responds to an asynchronous reset signal ASYNC_RST_B to inhibit write operations of the volatile memory controller 108 to the RAM 104 and to delay reset of the processing system 102 until the write operations are inhibited.

In more detail, the reset controller 402 asserts a complementary reset signal GLOBAL_RESET_B on a reset bus 404 to trigger reset synchronously with the system clock signal CLOCK, or asynchronously, or when power supply voltage is initially applied or is restored in a power-on reset in response to assertion of a power-on reset signal POR_B on a pin 406. The reset controller 402 triggers reset in the relevant domain of the processing system 102. Synchronous system resets include software resets and watchdog resets, for example. Assertion of the complementary asynchronous reset signal ASYNC_RST_B on the reset input pin 112 occurs without synchronization with the system clock, or in the presence of disturbances or glitches to the system clock.

The reset controller 402 asserts a reset signal to trigger reset. In this example, complementary logic is used for reset of the elements of the processing system 102 so that assertion of the reset signal corresponds to the voltage of the complementary reset signal GLOBAL_RST_B on the reset bus 404 being set to low. However it will be appreciated that assertion of a signal instead of a complementary signal and high instead of low voltage values are possible if the logic circuits are suitably adapted.

The reset controller 402 responds to the assertion of a power-on reset signal (low voltage of the complementary power-on reset signal POR_B) to reset the processing system 102 during a power-on reset period defined by a number of the system clock signals CLOCK. In this example, the data processor 400 includes a six-stage binary counter that counts the system clock signals CLOCK to extend the power-on reset period so that sixty-four valid system clock signals CLOCK occur before the end of the power-on reset, leaving time for the clock to stabilize after the power supply is switched ON or restored.

The reset controller 402 responds to an asynchronous reset signal to reset the processing system 102 after an asynchronous reset delay defined by a number of the system clock signals CLOCK. In this example, the asynchronous reset delay is defined by assertion of a signal (voltage low) at an output 408 of a chain 410 of four flip-flops whose input receives the complementary asynchronous reset signal ASYNC_RST_B, the flip-flops of the chain 410 being clocked by the system clock signals CLOCK, so that the changes of the signal at the output 408 are delayed by four cycles of the system clock signals CLOCK relative to the complementary asynchronous reset signal ASYNC_RST_B. The signal at the output 408 of the chain 410 is applied to a ‘1’ input of a multiplexer 412, whose inverse ‘0’ input receives the complementary asynchronous reset signal ASYNC_RST_B from the pin 112 directly.

The reset controller 402 includes a clock signal monitor 414. The reset controller 402 responds to an asynchronous reset signal ASYNC_RST_B to reset the processing system 102 without the asynchronous reset delay if the clock signal monitor 414 does not indicate presence of valid system clock signals CLOCK. The clock signal monitor 414 includes an internal clock generator (not shown) and indicates presence of the system clock signals CLOCK in response to edges of the system clock signal occurring within a delay defined by a number of internal clock signals from the internal clock generator. In this example, the reset controller 402 includes an AND gate 415 that receives the output of the multiplexer 412 on one input and the complementary power-on reset signal POR_B on another input. The output of the AND gate 415 is applied to the reset bus 404 so that the complementary reset signal GLOBAL_RST_B is asserted (voltage low), to reset the processing system 102 if either of the inputs of the AND gate 415 is asserted. Accordingly, the output of the AND gate 415 is asserted, immediately a power-on reset is requested, or if the output of the delay chain 410 is asserted after timing the delay of an asynchronous reset request, or if the complementary asynchronous reset signal ASYNC_RST_B is asserted and the clock monitor 414 does not detect valid system clock signals CLOCK. The clock monitor 414 asserts a signal CLOCK_PRESENT at the multiplexer 412 unless no valid clock signals CLOCK are detected, in which case the multiplexer 412 passes the complementary asynchronous reset signal ASYNC_RST_B to its output as the complementary reset signal GLOBAL_RST_B. The output of the AND gate 415 is only de-asserted (voltage high), to leave the processing system 102 functioning, if both the inputs of the AND gate 415 are de-asserted. Immediate reset of the processing system 102 in response to a power-on reset request or absence of valid system clock signals is acceptable, since no valid data or system clock signals for write operations into the RAM module 104 are available and it prevents use of the system clock signal before it is stable.

The reset controller 402 responds to an asynchronous reset signal ASYNC_RST_B by synchronously inhibiting write operations of the volatile memory controller 108 into the volatile memory module 104 after an inhibit delay defined by a number of the system clock signals CLOCK. In this example, the inhibit delay is defined by assertion of an inhibit signal SAFE_STATE_RAM_B (voltage low) at an output 416 of a chain 418 of two flip-flops whose input receives the complementary asynchronous reset signal ASYNC_RST_B, the flip-flops of the chain 418 being clocked by the system clock signals CLOCK. In this example, the changes of the signal at the output 416 are delayed by two cycles of the system clock signals CLOCK relative to the complementary asynchronous reset signal ASYNC_RST_B. The inhibit delay allows the inhibit operation to occur synchronously, provided valid system clock signals CLOCK are present.

In response to the assertion of the complementary power-on reset signal POR_B, the reset controller 402 resets the reset delay elements timing delay of reset of said processing system during the power-on reset period in response to an asynchronous reset signal. In this example, the reset delay elements are the flip-flops of the chain 410. In response to the assertion of the complementary power-on reset signal POR_B, the reset controller 402 also resets during the power-on reset period the inhibit delay elements timing delay of inhibit of write operations of the volatile memory controller into the volatile memory module. In this example, the inhibit delay elements are the flip-flops of the chain 418.

The volatile memory controller 108 provides control signals RAM_CS_B on a line 116 for volatile memory write operations of the output signals of the processing system 102. The volatile memory controller 108 also provides control signals WRITE_ENABLE and data signals WRITE_DATA and WRITE_ADDRESS (not shown in FIG. 4) to the volatile memory module 104. The signals RAM_CS_B, WRITE_ENABLE, WRITE_DATA and WRITE_ADDRESS applied to the input of the volatile memory module 104 are normally synchronized with the system clock signals CLOCK. A multiplexer 420 receives the data write signals RAM_CS_B on one input and provides signals FINAL_RAM_CS_B to an input 422 of the volatile memory module 104. Another input of the multiplexer 420 receives a signal OFF_VALUE which ensures that the input signal of the volatile memory module 104 is not indeterminate when the output of the processing system 102 is in the reset state. The output of the multiplexer 420 is blocked by assertion of the inhibit signal SAFE_STATE_RAM_B at the output 416 of the chain 418, to inhibit write operations from the volatile memory controller 108 into the volatile memory module 104.

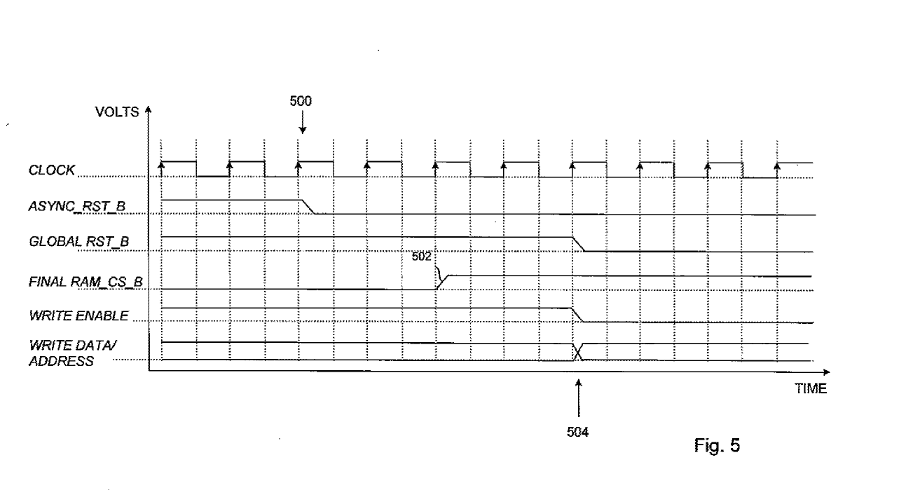

FIG. 5 illustrates signals appearing in one example of operation of the data processor 400. The assertion of the complementary asynchronous reset signal ASYNC_RST_B on the reset input pin 112 occurs at an instant 500. The complementary reset signal GLOBAL_RST_B on the reset bus 404 remains de-asserted after the instant 500 during the reset delay timed by the chain 410 of flip-flops. The complementary output signal FINAL_RAM_CS_B from the multiplexer 420 is de-asserted synchronously at instant 502 at the end of the inhibit delay, two cycles of the system clock signals CLOCK after the instant 500, when the inhibit signal SAFE_STATE_RAM_B inhibits write operations from the volatile memory controller 108 into the volatile memory module 104. The complementary reset signal GLOBAL_RST_B on the reset bus 404 is asserted synchronously at an instant 504, four cycles of the system clock signals CLOCK after the instant 500 at the end of the reset delay timed by the chain 410 of flip-flops. The elements of the processing system 102 then reset. At the instant 504, the control signal WRITE_ENABLE and data signals WRITE_DATA and WRITE_ADDRESS may change value but do not propagate to the volatile memory module 104, since they are blocked by the multiplexer 420.

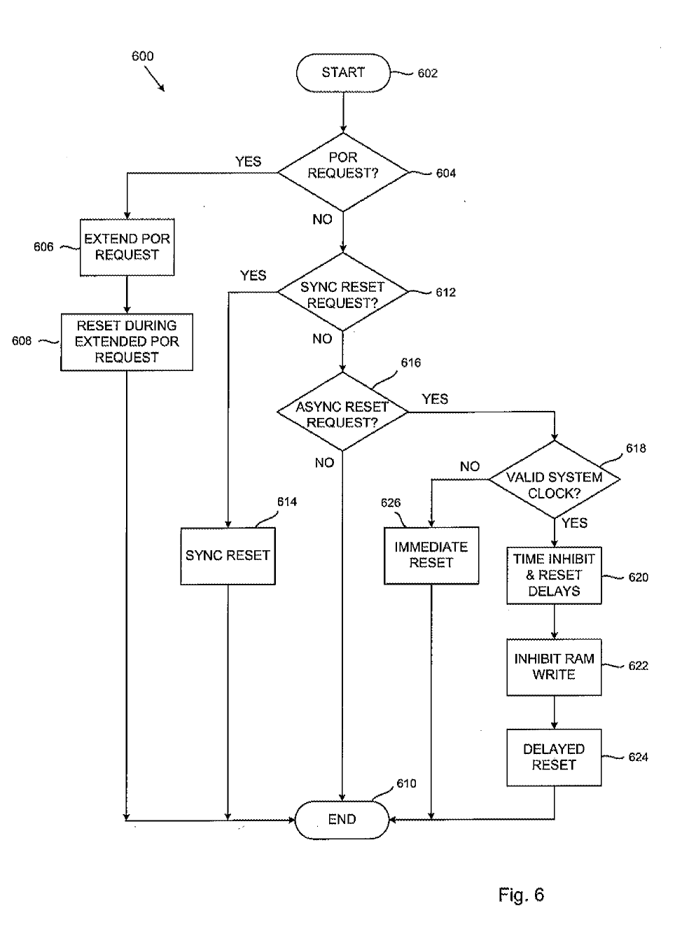

FIG. 6 is a flow chart that summarizes an example of a method 600 of performing reset in operation of a processing system in a data processor having a volatile memory module in response to a reset request in accordance with an embodiment of the invention. The method starts at 602. At 604, the method detects whether a power-on reset request is asserted. If a power-on reset request is asserted at 604, the method extends the power-on reset request at 606 for a defined number of cycles of system clock, in this example sixty-four cycles. Reset of the processing system is asserted at 608 during the whole of the extended power-on request, to ensure that the system clock can stabilize before the end of the reset. The reset then ends at 610 and normal operation of the data processor starts.

If no power-on reset request is asserted at 604, the method detects at 612 whether a synchronous reset request is asserted. If a synchronous reset request is asserted at 612, reset of the processing system is asserted at 614, in this example after a brief delay of one system clock cycle, to ensure any write operation in the volatile memory module is completed first. The reset then ends at 610 and normal operation of the data processor starts.

If no synchronous reset request is asserted at 612, the method detects at 616 whether an asynchronous reset request is asserted. If at 616 an asynchronous reset request is asserted, the method checks at 618 whether valid system clock signals are present. If valid system clock signals are present at 618, at 620 the method times inhibit and reset delays, the inhibit delay being shorter than the reset delay. In this example, the inhibit delay lasts two cycles of the system clock and the reset delay lasts four cycles of the system clock from assertion of the asynchronous reset request at 616. At the end of the inhibit delay, at 622 the method inhibits writing operations into the volatile memory module. Subsequently, at the end of the reset delay, delayed reset of the processing system is asserted at 624. The reset then ends at 610 and normal operation of the data processor starts.

If valid system clock signals are not present at 618, a reset of the processing system is asserted immediately at 626. The reset then ends at 610 and normal operation of the data processor starts. If at 616 no asynchronous reset request is asserted, normal operation of the data processor continues without reset.

The invention may be implemented using portions of processor code for performing steps of a method according to the invention when run on a programmable apparatus, such as a computer system or enabling a programmable apparatus to perform functions of a device or system according to the invention.

A computer program is a list of instructions such as a particular application program and/or an operating system in processor code. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

The terms “assert” or “set” and “negate” (or “de-assert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. The examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

In the claims, the word ‘comprising’ or ‘having’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

1. A data processor, comprising:
a processing system including a volatile memory module;
a volatile memory controller for writing data to said volatile memory module, wherein operations of said processing system and said volatile memory controller are synchronized by system clock signals; and
a reset controller for controlling reset of said processing system, wherein, in response to an asynchronous reset signal, said reset controller inhibits write operations of said volatile memory controller to said volatile memory module, and delays reset of said processing system until said write operations are inhibited.

2. The data processor of claim 1, wherein said volatile memory module is random access memory (RAM).

3. The data processor of claim 1, wherein said reset controller responds to the assertion of a power-on reset signal to reset said processing system during a power-on reset period defined by a number of said system clock signals.

4. The data processor of claim 3, wherein said reset controller includes reset delay elements for delaying the reset of said processing system, and wherein said reset controller resets said reset delay elements during said power-on reset period in response to said assertion of a power-on reset signal.

5. The data processor of claim 1, wherein said reset controller resets said processing system in response to said asynchronous reset signal conditionally on said power-on reset signal being de-asserted.

6. The data processor of claim 1, wherein said reset controller responds to said asynchronous reset signal to inhibit synchronously write operations of said volatile memory controller to said volatile memory module after an inhibit delay defined by a number of said system clock signals, wherein said reset controller includes inhibit delay elements for timing said inhibit delay, and said reset controller resets said inhibit delay elements during said power-on reset period in response to said assertion of a power-on reset signal.

7. The data processor of claim 1, wherein said reset controller responds to said asynchronous reset signal to reset said processing system after an asynchronous reset delay defined by a number of said system clock signals.

8. The data processor of claim 7, wherein said reset controller includes a clock signal monitor and said reset controller responds to said asynchronous reset signal to reset said processing system without said asynchronous reset delay if said clock signal monitor does not indicate presence of said system clock signals.

9. The data processor of claim 8, wherein said clock signal monitor includes an internal clock generator and indicates presence of said system clock signals in response to edges of said system clock signal occurring within a delay defined by a number of internal clock signals from said internal clock generator.

10. The data processor of claim 1, wherein said reset controller responds to said asynchronous reset signal to inhibit synchronously write operations of said volatile memory controller to said volatile memory module after an inhibit delay defined by a number of said system clock signals.

11. A method of performing a reset operation in a data processor having a processing system, a reset controller for controlling reset of said processing system, a volatile memory module, and a volatile memory controller for writing data to said volatile memory module, wherein the operations of said processing system and said volatile memory controller are synchronized by system clock signals, the method including:
receiving an asynchronous reset signal;
said reset controller responding to said asynchronous reset signal to inhibit write operations to said volatile memory module; and
said reset controller delaying reset of said processing system until said write operations are inhibited.

12. The method of claim 11, wherein said volatile memory module is random access memory.

13. The method of claim 11, wherein said reset controller responds to the assertion of a power-on reset signal to reset said processing system during a power-on reset period defined by a number of said system clock signals.

14. The method of claim 13, wherein said reset controller includes reset delay elements for timing a delay of reset of said processing system in response to said asynchronous reset signal, and said reset controller resets said reset delay elements during said power-on reset period in response to said assertion of a power-on reset signal.

15. The method of claim 13, wherein said reset controller resets said processing system in response to said asynchronous reset signal conditionally on said power-on reset signal being de-asserted.

16. The method of claim 11, wherein said reset controller resets said processing system after an asynchronous reset delay defined by a number of said system clock signals.

17. The method of claim 16, wherein said reset controller includes a clock signal monitor and said reset controller responds to said asynchronous reset signal to reset said processing system without said asynchronous reset delay if said clock signal monitor does not indicate presence of said system clock signals.

18. The method of claim 17, wherein said clock signal monitor includes an internal clock generator and indicates presence of said system clock signals in response to edges of said system clock signal occurring within a delay defined by a number of internal clock signals from said internal clock generator.

19. The method of claim 11, wherein said reset controller inhibits write operations of said volatile memory controller to said volatile memory module synchronously after an inhibit delay defined by a number of said system clock signals.

20. The method of claim 19, wherein said reset controller includes inhibit delay elements for timing said inhibit delay, and said reset controller resets said inhibit delay elements during said power-on reset period.
